(19) United States
(12) Patent Application Publication
(10) Pub. No.: US 2019/0180192 A1
(43) Pub. Date: Jun. 13, 2019

(54) AN INFORMATION PROCESSING SYSTEM, AN INFORMATION PROCESSING METHOD AND A COMPUTER READABLE STORAGE MEDIUM

(71) Applicant: NEC Corporation, Minato-ku, Tokyo (JP)

(72) Inventors: Daniel Georg ANDRADE SILVA, Tokyo (JP); Yotaro WATANABE, Tokyo (JP); Satoshi MORINAGA, Tokyo (JP); Kunihiko SADAMASA, Tokyo (JP)

(73) Assignee: NEC Corporation, Minato-ku, Tokyo (JP)

(21) Appl. No.: 16/323,285

(22) PCT Filed: Aug. 18, 2016
(86) PCT No.: PCT/JP2016/003774

§ 371 Date: Feb. 5, 2019

(51) Int. Cl. G06N 5/02; G06F 16/901; G06N 7/00

(52) U.S. Cl. CPC G06N 5/025; G06N 7/005; G06F 16/9024

(57) ABSTRACT

An information processing system for learning new probabilistic rules even if only one training sample is given. A learning system (100) includes a KB (knowledge base) storage (110), a rule generator (130), and a weight calculator (140). The KB storage (110) stores a KB including a knowledge storage for storing rules between events among a plurality of events. The rule generator (130) generates one or more new rules based on the rules and an implication score between the events. The weight calculator (140) calculates a weight of the one or more new rules for probabilistic reasoning based on the implication score.

### TECHNICAL FIELD

The present invention relates to an information processing system, an information processing method and a computer readable storage medium thereof.

### BACKGROUND ART

As a method of reasoning, probabilistic reasoning based on a knowledge base (also referred to as KB) is known. In probabilistic reasoning, when an observation and a query (target event) are inputted, a probability of the query given observation is calculated based on a set of rules in KB. Markov Logic Network (also referred to MLN) disclosed in NPL 4 is an example of the probabilistic reasoning. In probabilistic reasoning, as shown in NPL4, a probability or weight is assigned to each rule in KB.

The probabilistic reasoning, as well as deterministic reasoning, can suffer from incomplete rules in KB. However, manually defining a set of rules for KB is labor-intensive. Therefore, several methods for automatically learning new rules from data have been proposed for various probabilistic reasoning frameworks. For example, in NPL 1, a method for learning Horn clauses for logic and relational learning based on Kernels is disclosed. In NPL 2, a method for structure learning of Bayesian Networks with priors is disclosed. In NPL 3, a method for structure learning of MLN is disclosed. These methods need large training data with samples n>>1. Here each training data sample is a set of joint observations from the past.

Note that, as a related technology, PTL1 discloses a text implication assessment device which assesses whether a text implies another text based on a feature value for the combination of texts. PTL2 discloses a knowledge base including a hyper graph which consists of edges each having a cost value.

### CITATION LIST

### Patent Literature

### [PTL 1]

International Publication WO2013/058118

### [PTL 2]

Japanese Patent Application Laid-Open Publication H07-334368

### Non Patent Literature

### [NPL 1]

Paolo Frasconi, et al., “k Log: A Language for Logical and Relations Learning with Kernels”, Artificial Intelligence, Volume 217, p.p. 117-143, December 2014.

### [NPL 2]

Vikash Mansinghka, et al., “Structured Priors for Structure Learning”. Proceedings of the Twenty-Second Conference on Uncertainty in Artificial Intelligence (UAI 2006), July 2006.

### [NPL 3]

Jan Van Haaren, et al., “Lifted generative learning of Markov logic networks”, Machine Learning, Volume 103, Issue 1, p.p. 27-55, April 2016.

### [NPL 4]

Matthew Richardson, et al., “Markov logic networks”, Machine Learning, Volume 62, Issue 1, p.p. 107-136, February 2006.

### SUMMARY OF INVENTION

### Technical Problem

In the NPLs described above, n number of training samples, with n>>1, are required to learn general rules without over-fitting. However, it is not always possible to obtain such large training data. In an extreme case, there is only one training sample.

An object of the present invention is to resolve the issue mentioned above. Specifically, the object is to provide an information processing system, an information processing method and a computer readable storage medium thereof which allows to learn new probabilistic rules even if only one training sample is given.

### Solution to Problem

An information processing system according to an exemplary aspect of the invention includes: a knowledge storage for storing rules between events among a plurality of events; a rule generation means for generating one or more new rules based on the rules and an implication score between the events; and a weight calculation means for calculating a weight of the one or more new rules for probabilistic reasoning based on the implication score.

An information processing method according to an exemplary aspect of the invention includes: generating one or more new rules based on rules between events among a plurality of events and an implication score between the events; and calculating a weight of the one or more new rules for probabilistic reasoning based on the implication score.

A computer readable storage medium according to an exemplary aspect of the invention records thereon a program, causing a computer to perform a method including: generating one or more new rules based on rules between events among a plurality of events and an implication score between the events; and calculating a weight of the one or more new rules for probabilistic reasoning based on the implication score.

### Advantageous Effects of Invention

An advantageous effect of the present invention is to learn new probabilistic rules even if only one training sample is given.

### BRIEF DESCRIPTION OF DRAWINGS

FIG. 1 is a block diagram illustrating a characteristic configuration of an exemplary embodiment of the present invention.

FIG. 2 is a block diagram illustrating a configuration of a learning system 100 in the exemplary embodiment.

FIG. 3 is a block diagram illustrating a configuration of the learning system 100 in the exemplary embodiment, in the case that the learning system 100 is implemented on a computer.

FIG. 4 is a flowchart illustrating a process of the learning system 100 in the exemplary embodiment.

FIG. 5 is a diagram illustrating an example of rules in KB in the exemplary embodiment.

FIG. 6 is a diagram illustrating an example of a grounded network based on the rules in the KB in the exemplary embodiment.

FIG. 7 is a diagram illustrating an example of possible new edges and scores in the exemplary embodiment.

FIG. 8 is a diagram illustrating an example of selection of a new edge in the exemplary embodiment.

FIG. 9 is a diagram illustrating another example of possible new edges and scores in the exemplary embodiment.

FIG. 10 is a diagram illustrating still another example of possible new edges and scores in the exemplary embodiment.

FIG. 11 is a diagram illustrating an example of a part of graph with respect to a new rule in the exemplary embodiment.

### DESCRIPTION OF EMBODIMENTS

An exemplary embodiment of the present invention will be described below.

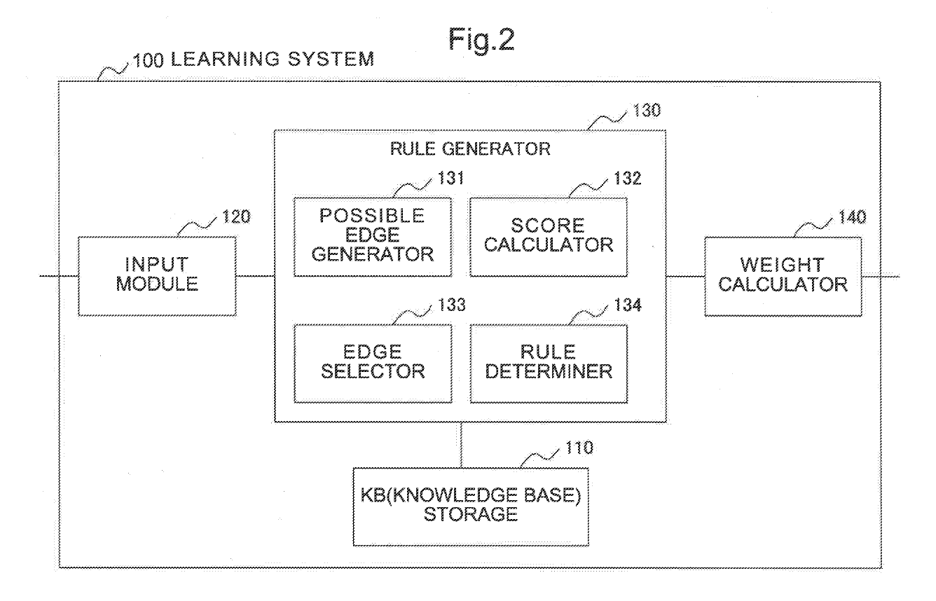

First of all, a configuration of the exemplary embodiment of the present invention will be described. FIG. 2 is a block diagram illustrating a configuration of a learning system 100 in the exemplary embodiment. The learning system 100 is an exemplary embodiment of an information processing system of the present invention. With reference to FIG. 2, the learning system 100 in the exemplary embodiment includes KB (knowledge base) storage (also referred to as a knowledge storing module) 110, an input module 120, a rule generator (also referred to as a rule generation module) 130, and a weight calculator (also referred to as a weight calculation module) 140. The rule generator 130 includes a possible edge generator 131, a score calculator 132, an edge selector 133, and a rule determiner 134.

The KB storage 110 stores KB including one or more rules between events.

FIG. 5 is a diagram illustrating an example of rules in KB in the exemplary embodiment.

In KB of FIG. 5, there are the following three rules: (X, sell, Y)=>(X, earn, Z), (X, sell, Y)=>(X, drop, Y), and (X, drop, Y)=>(X, go bankrupt). Here, “(X, sell, Y)” represents an event “X sells Y” as a predicated argument structure with a verb “sell”, a semantic subject “X”, and a semantic object “Y”. The symbol “=>” indicates an implication relation in which an event at the left side of the symbol corresponds to a premise and an event at right side of the symbol corresponds to a conclusion. The term “implication” here is used in a broad sense including textual entailment like “Peter buys book”=>“Peter owns book”, as well as future prediction like “Peter buys book”=>“Peter sells book”. For simplicity, it is assumed that each rule contains one event of the premise and one event of the conclusion (Horn clauses). In probabilistic reasoning, as shown in NPL4, a probability or weight is assigned to each rule.

It is assumed that the rules in KB are generated based on a plurality of training samples and stored in KB, in advance.

Here, an event like (X, sell, Y) is called an ungrounded event, with placeholder X and Y for the subject and object, respectively. In contrast an event like (ABC, sell, computer) is called a grounded event, where each placeholder is replaced by an entity.

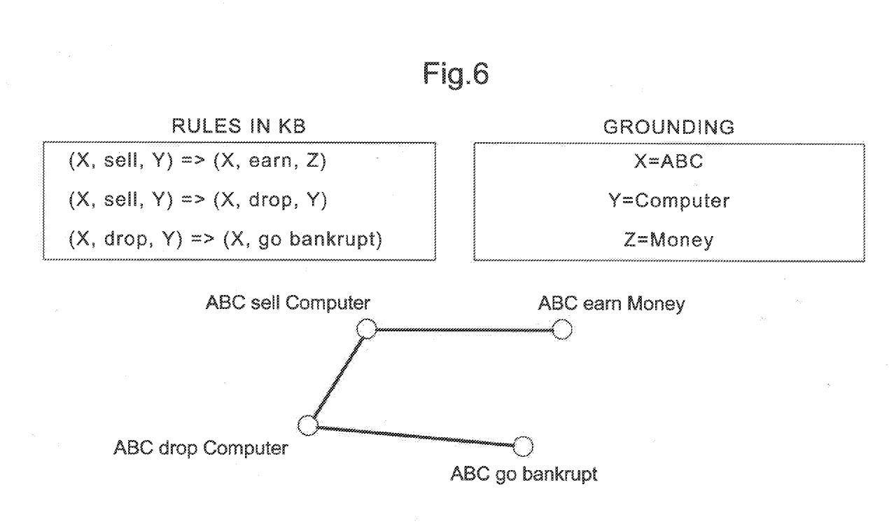

FIG. 6 is a diagram illustrating an example of a grounded network based on the rules in the KB in the exemplary embodiment.

In FIG. 6, a grounded network is represented as a graph with undirected edges. In the graph, each node corresponds to a grounded event, and each edge between two nodes corresponds to a rule between the two events. The edge is drawn if and only if the corresponding two events occur in the same rule. Note that, in general, more complex rules, like rules that involve conjunctions of events, are also possible.

With the help of KB, a probabilistic query can be performed. For example, it is possible to determine a probability of a certain target event T given a certain set of observations (observed events) O. For example, when an observation and a target event are defined as eₒ: =(ABC, sell, computer) and eₜ:=(ABC, go bankrupt), probability P(T=eₜ|O={eₒ}) can be calculated according to NPL 4, for example.

However, when an observation and a target event are defined as eₒ:=(ABC, produce, computer) and eₜ:=(ABC, go bankrupt), since the observation and a rule related to the observation are not defined in the KB shown in FIG. 5, that is, the observation eₒ is an unknown observation, the observation {eₒ} is irrelevant for determining P(T=eₜ|O={eₒ}). In other words, the probability is expressed as P(T=eₜ|O={eₒ})=P(T=eₜ).

Based on the description above, “rule is missing” in the KB is defined if and only if “∃eₒ∈O: There is no path in the grounded network connecting the observed event eₒ and the target event eₜ”. Note that no path between eₒ and the target event eₜ is a sufficient condition for P(T=eₜ|O={eₒ})=P(T=eₜ).

The definition of a missing rule makes the implicit assumption that every observation has a direct or indirect impact on the outcome of the target event. However, this assumption is not always true. For example, an event like (Peter, buy, ice cream) is very likely to be not related to the outcome of eₜ=(ABC, go bankrupt). In general, such irrelevant events can be easily filtered out.

According to the above assumption, there is one or more rules missing that connects (directly or indirectly) the observation eₒ=(ABC, produce, computer) with the target event eₜ=(ABC, go bankrupt).

In the exemplary embodiment, the new rule (missing rule) is generated based on the new edge selected from possible new edges on the graph. The possible new edge is defined as an edge that connects sub-graphs including an observation or a target event, on the graph. Here the sub-graph is a part of the graph, and consists of nodes and edges obtained by exploring nodes connected by edges in the graph. A node not connected to any other node (an independent node) is also considered as a sub-graph.

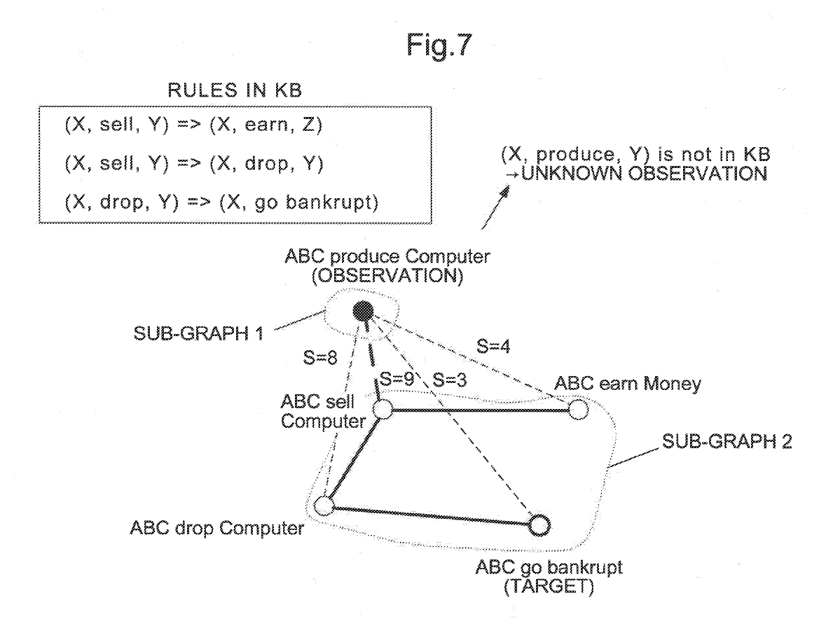

FIG. 7 is a diagram illustrating an example of possible new edges and scores in the exemplary embodiment.

The input module 120 receives a set of observations and a target event as a new training sample, from a user or the like.

The possible edge generator 131 of the rule generator 130, when the set of observations and the target event is inputted, generates possible new edges for the inputted set of observations and target event.

In FIG. 7, the graph consists of sub-graph 1 including the observation (ABC, produce, computer) and sub-graph 2 including the target event (ABC, go bankrupt). For example, the possible edge generator 131 generates the possible new edges that connect sub-graph 1 and sub-graph 2 as shown in broken lines in FIG. 7.

In order to select the new edge from among the possible new edges, the score calculator 132 calculates an edge score S of each possible new edge. Here, the edge score S is defined as S(a, b)=max {s(a, b), s(b, a)}, where s(a, b) is an implication score between events a and b, which represents how likely it is that the event a implies the event b. The score calculator 132 calculates the implication score s for example using One-Step-Predictor (OSP) method described below.

In the OSP method, first, each word in the events a and b is mapped to a word embedding having dimension d. Next, event embeddings eₐ and e_{b} for events a and b, having dimension h are generated using the word embeddings. Finally, the implication scores s(a, b) and s(b, a) are calculated using the event embeddings eₐ and e_{b} and a predetermined weight matrix.

For example, the score calculator 132 calculates an edge score S for each possible new edge as shown in FIG. 7. The advantage of the OSP method is that an edge score between any two events can be calculated. However, since the OSP is just a heuristic, in general, no reliable scores can be calculated. As a consequence, among the possible new rules for which the edge scores S have been calculated by the OSP, only as few rules as necessary should be included into the KB.

Formally, the goal can be stated as: Given a set of observations and KB with one or more missing rules, augment the KB in order to find the most plausible and simplest reasoning path.

This goal can be achieved, for example, by selecting the least number of possible new edges, as new edges, such that all sub-graphs that contain an observation or a target event are connected and the total of edge scores of the selected possible new edges is maximized.

The edge selector 133 selects new edges from the generated possible new edges based on the edge scores.

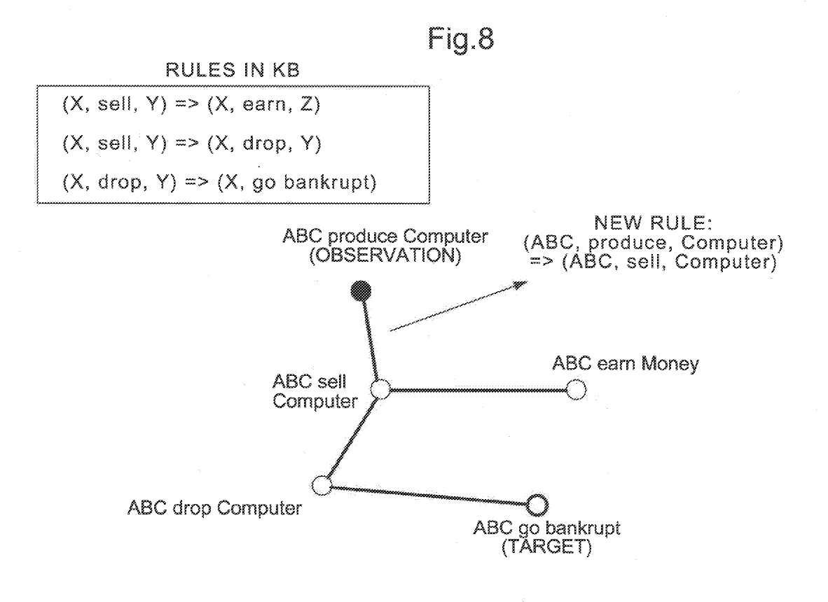

FIG. 8 is a diagram illustrating an example of selection of a new edge in the exemplary embodiment. In FIG. 7, the possible new edge between the event (ABC, produce, computer) in sub-graph 1 and the event (ABC, sell, computer) in sub-graph 2 has the maximum edge score “9”. In this case, the edge selector 133 selects the possible new edge between the events (ABC, produce, computer) and (ABC, sell, computer) as a new edge, as shown in FIG. 8.

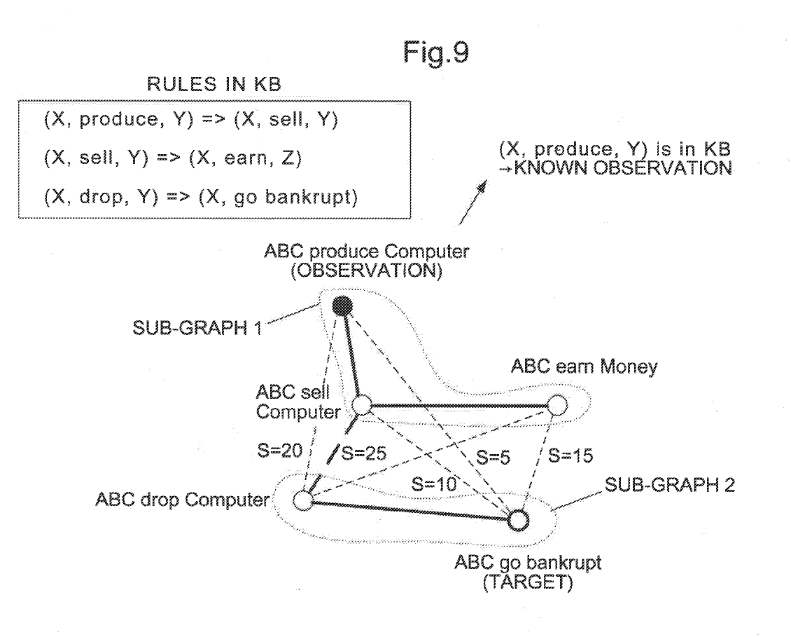

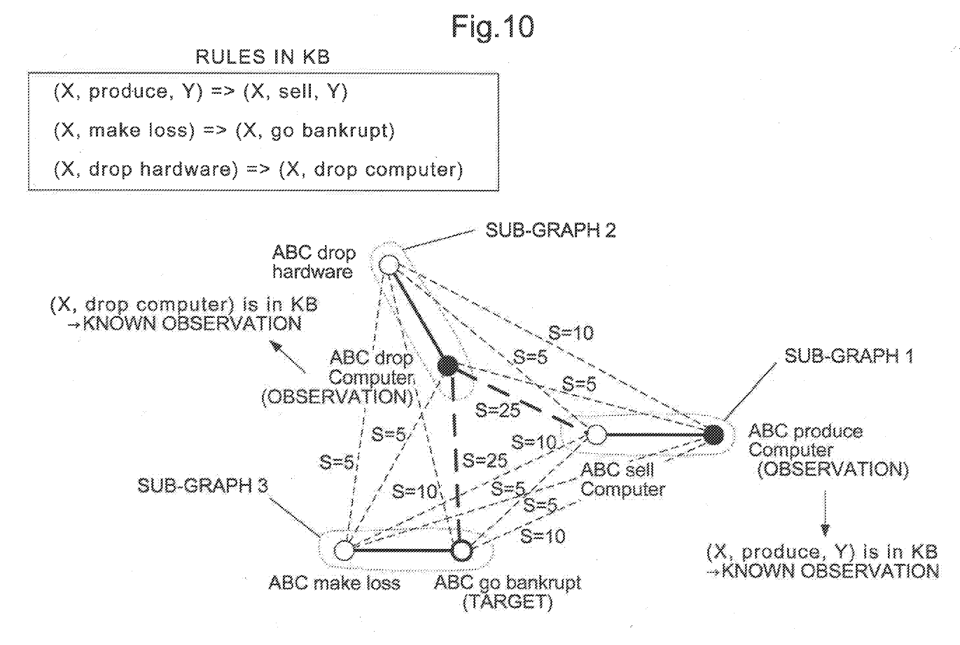

FIG. 9 and FIG. 10 are diagrams illustrating another example of possible new edges and scores in the exemplary embodiment.

In FIG. 9, an observation and a target event are defined as follows: eₒ:=(ABC, produce, computer); and eₜ:=(ABC, go bankrupt). The observation eₒ is defined in the KB, that is, the observation eₒ is a known observation. The graph consists of sub-graph 1 including the observation (ABC, produce, computer) and sub-graph 2 including the target event (ABC, go bankrupt). In this case, the possible new edge between the event (ABC, sell, computer) in sub-graph 1 and the event (ABC, drop, computer) in sub-graph 2 has the maximum edge score “25”. The edge selector 133 selects the possible new edge between the events (ABC, sell, computer) and (ABC, drop, computer) as a new edge.

In FIG. 10, observations and a target event are defined as follows: {eₒ}:={(ABC, produce, computer), (ABC, drop, computer)}; and eₜ:=(ABC, go bankrupt). The observations {eₒ} are defined in the KB, that is, the observations are a known observation. The graph consists of sub-graph 1 including the observation (ABC, produce, computer), sub-graph 2 including the observation (ABC, drop, computer), and sub-graph 3 including the target event (ABC, go bankrupt). In this case, the total of edge scores of the possible new edge between the event (ABC, sell, computer) in sub-graph 1 and the event (ABC, drop, computer) in sub-graph 2, and the possible new edge between the event (ABC, drop, computer) in sub-graph 2 and the event (ABC, go bankrupt) in sub-graph 3 is the maximum value “50”. The edge selector 133 selects these possible new edges as new edges.

Next, the rule determiner 134 determines, with respect to the selected new edge, a new rule to be added based on the implication score. Here, the rule determiner 134, with respect to the selected new edge between event a and event b, determines a rule a=>b as a new rule if s(a, b)>s(b, a), otherwise a rule b=>a as a new rule, for example.

In case of FIG. 8, there are two choices: (ABC, produce, computer)=>(ABC, sell, computer), and (ABC, sell, computer)=>(ABC, produce, computer). If s((ABC, sell, computer), (ABC, produce, computer))=6, and s((ABC, produce, computer), (ABC, sell, computer))=9, the rule determiner 134 determines the rule (ABC, produce, computer)=>(ABC, sell, computer) as a new rule.

At this point, a reasoning path for deterministic logical reasoning, that is a reasoning path from the observation eₒ=(ABC, produce, computer) to the target event eₜ=(ABC, go bankrupt), has been obtained. For performing probabilistic reasoning, it is further needed to calculate the probability P((ABC, go bankrupt)|(ABC, produce, computer)). In the following, it is assumed that the probabilistic reasoning is performed using MLN disclosed by NPL 4. In this case, a weight for a new rule should be determined.

The weight calculator 140 calculates the weight for the new rule according to the following two steps. Here, it is assumed that a new rule r:(a=>b) is determined between an event a and an event b, and a weight wᵣ for the new rule r is to be calculated.

In the first step, the weight calculator 140 obtains a conditional probability using an implication score from OSP defined by Math. 1.

$${P}_{OSP} ( b \vert a ) := \frac{s ( a , b )}{{\sum }_{{b}^{′}} s ( a , {b}^{′} )} \qquad [ Math . 1 ]$$

Here it is assumed that all of implication scores are positive, events b′ (b′≠b) are exclusive each other. Note that, if an implication score s(a, b) has been defined in such a way as to show a probability (from 0 to 1), the weight calculator 140 may obtain the conditional probability defined by Math. 2.

P_{OSP}(b|a):=s(a,b) [Math. 2]

In the second step, the weight calculator 140 calculates the weight wᵣ assuming the weight is subjected to the following two conditions:

1. weights of all other rules in KB are unchanged

2. probability P(b|a) according to MLN equals to P_{OSP}(b|a).

As shown in the following, these two conditions uniquely define the weight wᵣ.

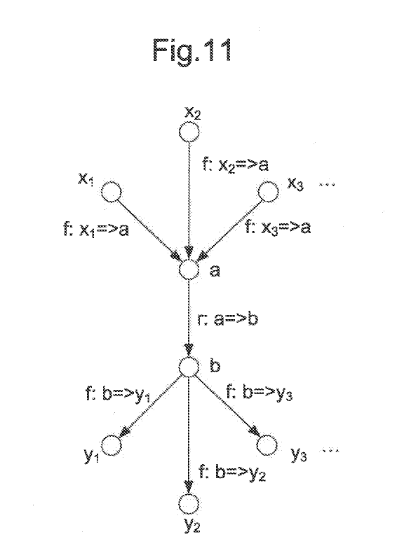

FIG. 11 is a diagram illustrating an example of a part of graph with respect to the new rule r:(a=>b) in the exemplary embodiment.

Let P_{MLN} denote a probability distribution defined by the weights of all rules in KB∪{a=>b}. Let a vector x denote events x₁, x₂, . . . that are directly connected to the event a as shown in FIG. 11. Analogously, let a vector y denote events y₁, y₂, . . . that are directly connected to the event b as shown in FIG. 11. Since there was no path between events a and b in the original graph, there are no events that are connected with both events a and b. In this case, the conditional probability P_{MLN}(b|a) according to MLN can be expressed by Math. 3.

$${P}_{MLN} ( b \vert a ) \\ ∝ p ( a , b ) = \sum p ( a , b , x , y ) \\ ∝ \underbrace{{e}^{{w}_{r} {1}_{r} ( a , b )}}_{t ( a , b )} \cdot \underbrace{{\sum }_{x} {e}^{{\sum }_{f ∈ Fa} {w}_{f} {1}_{f} ( x , a )}}_{g ( a )} \cdot \underbrace{{\sum }_{x} {e}^{{\sum }_{f ∈ Fb} {w}_{f} {1}_{f} ( b , x )}}_{g ( a )} \qquad [ Math . 3 ]$$

where lᵣ(a, b) is an indication function of rule r, i.e. l, if the rule r:(a=>b) is fulfilled, and 0 otherwise. l_{f}(x, a) and l_{f}(b, y) are also an indication function of rule f:(x=>a) and r:(b=>y), i.e. l, if the rule f is fulfilled, and 0 otherwise. Fₐ and F_{b} is a set of all rules that involve the event a and the event b, respectively.

In the following, it is explicitly indicated whether the event a or b is true or false, by writing a=T or b=T for the event being true, and a=F or b=F for the event being false.

The conditional probability P_{MLN}(b=T|a=T) is expressed by Math. 4 using t(a, b), g(a), and h(b) defined in Math. 3.

$${P}_{MLN} ( b = T \vert a = T ) = \frac{{P}_{MLN} ( b = T , a = T )}{{P}_{MLN} ( b = T , a = T ) + {P}_{MLN} ( b = F , a = T )} = \frac{t ( a = T , b = T ) \cdot g ( a = T ) \cdot h ( b = T )}{\begin{matrix}\underbrace{t ( a = T , b = T )}_{{e}^{{w}_{r}}} \cdot g ( a = T ) \cdot h ( b = T ) + \\ \underbrace{t ( a = T , b = F )}_{1} \cdot g ( a = T ) \cdot h ( b = F )\end{matrix}} = \frac{{e}^{{w}_{r}} \cdot h ( T )}{{e}^{{w}_{r}} \cdot h ( T ) + h ( F )} \qquad [ Math . 4 ]$$

From Math. 4, the correct weight wᵣ can be calculated by Math. 5.

wᵣ=logₑ(p·h(F))−logₑ(NT)−p·h(T)) [Math. 5]

where p is defined as p:=P_{OSP}(b=T|a=T).

The weight calculator 140 calculates the weight wᵣ using Math. 5. It is obvious that the weight for a new rule can be calculated with Math. 5 for the all of examples shown in FIG. 7, FIG. 9, and FIG. 10.

The weight calculator 140 outputs the generated new rule and the calculated weight for the new rule to the user or the like. Moreover, the weight calculator 140 may add the generated new rule and the calculated weight to the KB. In this case, the weight calculator 140 may add a new rule between ungrounded events that is converted from the generated new rule.

In addition, a reasoning module (not shown) in the learning system 100 may perform a probabilistic query to calculate a probability P(T=eₜ|O={eₒ}) using the generated new rule and the calculated weight.

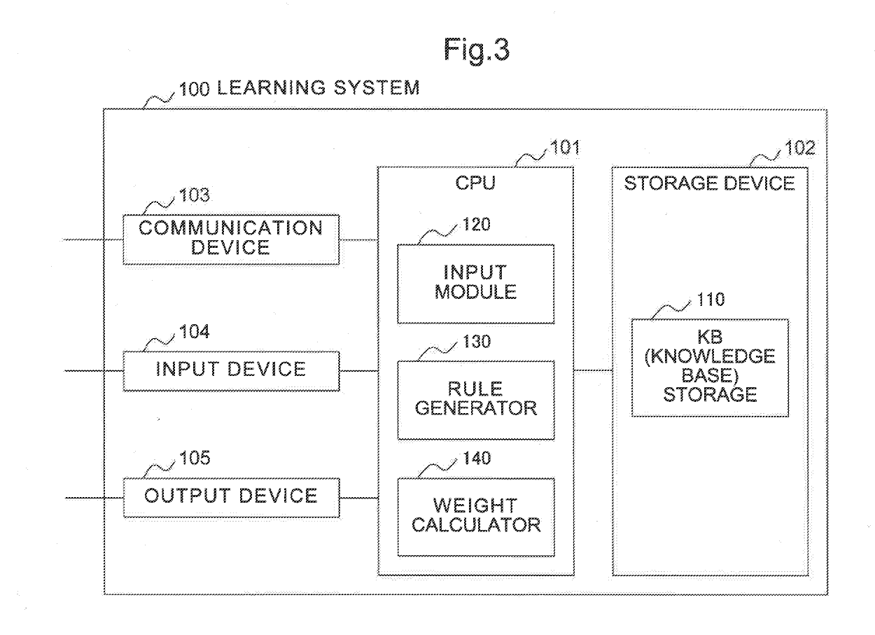

The learning system 100 may be a computer which includes a central processing unit (CPU) and a storage medium storing a program and which operates according to the program-based control. FIG. 3 is a block diagram illustrating a configuration of the learning system 100 in the exemplary embodiment, in a case that the learning system 100 is implemented on a computer.

With reference to FIG. 3, the learning system 100 includes a CPU 101, a storage device 102 (storage medium), a communication device 103, an input device 104 such as a keyboard, and an output device 105 such as a display. The CPU 101 executes a computer program to implement the functions of the input module 120, the rule generator 130, and the weight calculator 140. The storage device 102 stores information in the KB storage 110. The input device 104 may receive a training sample from a user or the like. The output device 105 may output (display) a new rule and weight of the new rule to the user or the like. The communication device 103 may receive the training sample from the other system and send the new rule and weight to the other system.

The modules in the learning system 100 in FIG. 3 may be allocated respectively to a plurality of devices interconnected with wired or wireless channels. A service of generating a new rule in the learning system 100 is provided to a user or the like as SaaS (Software as a Service).

The modules in the learning system 100 in FIG. 3 may be implemented on circuitry. Here, the term “circuitry” is defined as a term conceptually including a single chip, multiple devices, a chipset, or a cloud.

Next, operations of the learning system 100 according to the first exemplary embodiment of the present invention will be described.

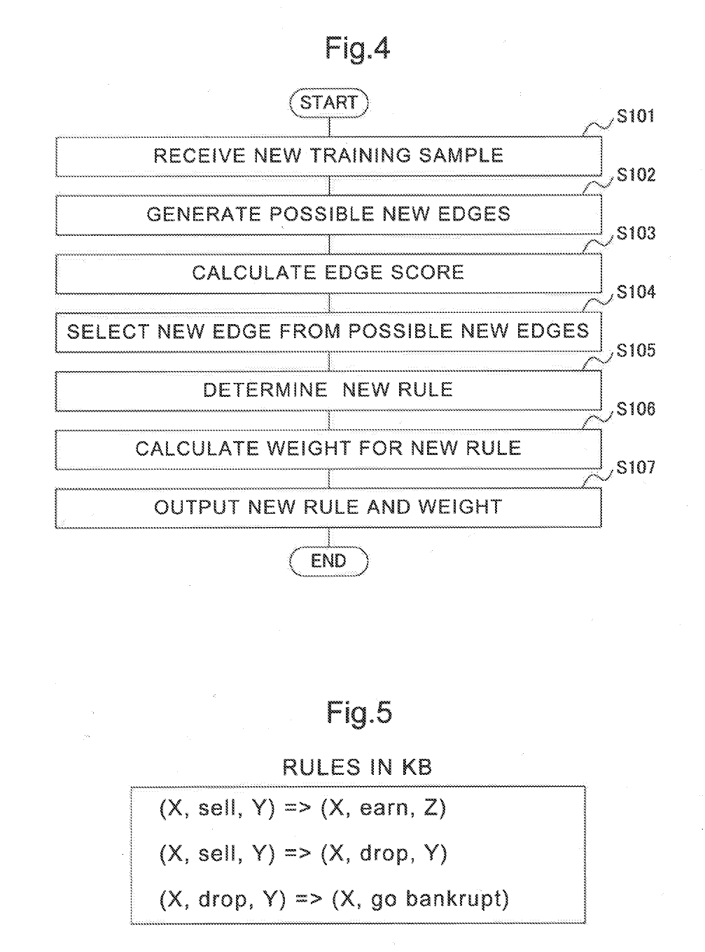

FIG. 4 is a flowchart illustrating a process of the learning system 100 in the exemplary embodiment. Here, it is assumed that the KB shown in FIG. 5 has been stored in KB storage 110 and the grounded network shown in FIG. 6 has been generated in the learning system 100.

The input module 120 receives a set of observations and a target event as a new training sample, from a user or the like (Step S101). For example, the input module 120 receives an observation eₒ=(ABC, produce, computer) and a target event eₜ=(ABC, go bankrupt).

The possible edge generator 131 generates possible new edges for the inputted set of observations and target event (Step S102). For example, the possible edge generator 131 generates possible new edges as shown in broken lines in FIG. 7.

The score calculator 132 calculates an edge score S of each possible new edge (Step S103). For example, the score calculator 132 calculates edge scores for the generated possible new edges as shown in FIG. 7.

The edge selector 133 selects new edges from the generated possible new edges based on the edge scores (Step S104). For example, the edge selector 133 selects, as new edges, the possible new edge between the event (ABC, produce, computer) and the event (ABC, sell, computer) as shown in FIG. 8.

The rule determiner 134 determines, with respect to the selected new edge, a new rule to be added based on the implication score (Step S105). For example, the rule determiner 134 determines the rule (ABC, produce, computer)=>(ABC, sell, computer) as a new rule.

The weight calculator 140 calculates a weight for the new rule based on the implication score and Math. 5 (Step S106). For example, the weight calculator 140 calculates a weight for the new rule (ABC, produce, computer)=>(ABC, sell, computer).

The weight calculator 140 outputs the generated new rule and the calculated weight (Step S107). For example, the weight calculator 140 outputs the new rule (ABC, produce, computer)=>(ABC, sell, computer) and the weight of the new rule.

As described above, the operation of the learning system 100 is completed.

In the exemplary embodiment described above, the rule generator 130 has generated a new rule by selecting, from possible new edges, the least number of possible new edges such that all sub-graphs that contain an observation or a target event are connected and the total of the implication scores of the selected possible new edges is maximized. Then, the weight calculator 140 has calculated a weight of the more new rule for probabilistic reasoning based on the implication score. However, as long as the new rule is generated based on the rules in KB and an implication score, and the weight is calculated based on the implication score, the other method may be used.

For example, instead of using the total of the implication scores, the rule generator 130 may use a joint probability of the observation and the target event. In this case, the rule generator 130 generates a new rule by selecting, from possible new edges, the least number of possible new edges such that all sub-graphs that contain an observation or a target event are connected and the joint probability of the observation and the target event is maximized. The joint probability of the observation and the target event is obtained according to MLN assuming a rule with respect to the selected possible new edge exists and using a weight of the selected possible new edge. The weight of the selected possible new edge is calculated by the weight calculator 140 using Math. 5.

Next, a characteristic configuration of the exemplary embodiment will be described.

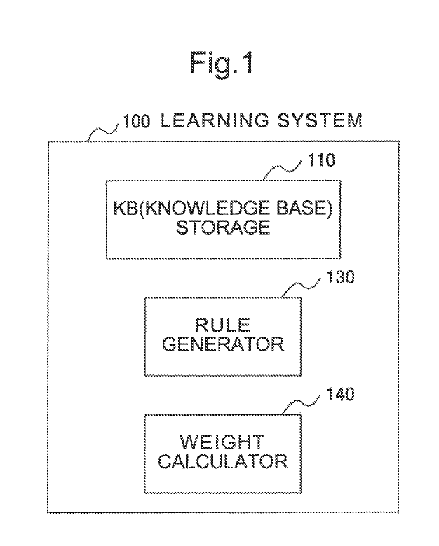

FIG. 1 is a block diagram illustrating a characteristic configuration of the exemplary embodiment.

With reference to FIG. 1, a learning system 100 includes a KB (knowledge base) storage 110, a rule generator 130, and a weight calculator 140. The KB storage 110 stores rules between events among a plurality of events. The rule generator 130 generates one or more new rules based on the rules and an implication score between the events. The weight calculator 140 calculates a weight of the one or more new rules for probabilistic reasoning based on the implication score.

According to the first exemplary embodiment of the present invention, it is possible to learn new probabilistic rules even if only one training sample is given. This is because the rule generator 130 generates one or more new rules based on rules between events among a plurality of events and an implication score between the events, and the weight calculator 140 calculates a weight of the one or more new rules for probabilistic reasoning based on the implication score.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention is applicable to a probabilistic logic-based reasoning system, or the like. Allowing automatic completion of rules is crucial in situations where it is not feasible (or too expensive) to generate all possible rules in advance.

### REFERENCE SIGNS LIST

100 learning system
101 CPU
102 storage device
103 communication device
104 input device
105 output device
110 KB storage
120 input module
130 rule generator
131 possible edge generator
132 score calculator
133 edge selector
134 rule determiner
140 weight calculator

What is claimed is:

1-9. (canceled)

10. An information processing system comprising:
a memory storing instructions; and
one or more processors configured to execute the instructions to:
store a knowledge base including rules between events among a plurality of events; and
generate one or more new rules between events based on weights of rules included in the knowledge base and an implication score between each pair of events for which a rule is not included in the knowledge base.

11. The information processing system according to claim 10,
wherein
the one or more processors are further configured to execute the instructions to:
calculate a weight between each pair of events for which a rule is not included in the knowledge base, based on a weight of a rule between one of the corresponding pair of events and an event other than the corresponding pair of events in the knowledge base, and an implication score between the corresponding pair of events, and
the one or more new rules are generated based on the weight calculated between each pair of events for which a rule is not included in the knowledge base.

12. The information processing system according to claim 10,
wherein
the one or more new rules are generated by selecting, from pairs of events for which a rule is not included in the knowledge base, the least number of pairs of events such that a joint probability of an observation event and a target event obtained by using the weight calculated for the selected pairs of events is maximized.

13. The information processing system according to claim 12,
wherein
the rules are represented by a graph including a node and an edge between nodes, the node corresponding to an event, the edge corresponding to a rule, and
the one or more new rules are generated by selecting, from the pairs of events for which a rule is not included in the knowledge base, the least number of pairs of events such that all sub-graphs that contain the observation event or the target event are connected and the joint probability is maximized.

14. An information processing method comprising:
storing a knowledge base including rules between events among a plurality of events; and
generating one or more new rules between events based on weights of rules included in the knowledge base and an implication score between each pair of events for which a rule is not included in the knowledge base.

15. The information processing method according to claim 14, further comprising:
calculating a weight between each pair of events for which a rule is not included in the knowledge base, based on a weight of a rule between one of the corresponding pair of events and an event other than the corresponding pair of events in the knowledge base, and an implication score between the corresponding pair of events,
wherein
the one or more new rules are generated based on the weight calculated between each pair of events for which a rule is not included in the knowledge base.

16. The information processing method according to claim 14,
wherein
the one or more new rules are generated by selecting, from pairs of events for which a rule is not included in the knowledge base, the least number of pairs of events such that a joint probability of an observation event and a target event obtained by using the weight calculated for the selected pairs of events is maximized.

17. The information processing method according to claim 16,
wherein
the rules are represented by a graph including a node and an edge between nodes, the node corresponding to an event, the edge corresponding to a rule, and
the one or more new rules are generated by selecting, from the pairs of events for which a rule is not included in the knowledge base, the least number of pairs of events such that all sub-graphs that contain the observation event or the target event are connected and the joint probability is maximized.

18. A non-transitory computer readable storage medium recording thereon a program, causing a computer to perform a method comprising:
storing a knowledge base including rules between events among a plurality of events; and
generating one or more new rules between events based on weights of rules included in the knowledge base and an implication score between each pair of events for which a rule is not included in the knowledge base.
